(19) United States
(12) Patent Application Publication
(10) Pub. No.: US 2007/0254616 A1
(43) Pub. Date: Nov. 1, 2007

(54) Receiver dynamic range enhancement

(76) Inventors: Joseph M. Gorin, Santa Rosa, CA (US); Brian Joseph Avenell, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/414,436

(22) Filed: Apr. 28, 2006

(51) Int. Cl. H04B 1/26

(52) U.S. Cl. 455/323

(57) ABSTRACT

Frequency converters amplitude-divide an input signal to provide two signals that are applied to corresponding mixers that frequency translate the signals according to an LO signal, to provide corresponding IF signals that are summed to provide an output IF signal.

### BACKGROUND OF THE INVENTION

Dynamic range is an important performance parameter of spectrum analyzers and other types of receivers. Dynamic range is a measure of the capability of a receiver to accommodate high level signals, such as a carrier signal, relative to the sensitivity of the receiver to measure or detect low level signals, such as modulation sidebands of the carrier signal. For example, a receiver may receive an applied signal having a carrier signal at a power level of +20 dBm, whereas modulation sidebands of the carrier signal may be greater than 90 dB below the power level of the carrier signal. In order to accommodate signals that have large differences in signal levels, it is a performance advantage for the spectrum analyzer to have high dynamic range.

One measure of dynamic range is depicted by the ratio of the third-order intercept (TOI) of the receiver to the noise of the receiver. The TOI is a figure of merit for nonlinearity of the receiver in the presence of high level signals. The TOI is limited by nonlinear elements, such as a mixer, in a frequency conversion stage of the receiver (shown in FIG. 1). Accordingly, the TOI represents an upper limit to the level of the signals that can be accommodated by the receiver. In contrast, the noise of the receiver establishes a lower limit to the level of the signals that can be accommodated by the receiver. Noise is typically expressed in terms of noise power (NP) within a designated bandwidth, noise density (ND), noise figure (NF), or displayed average noise level (DANL) of the receiver.

In a conventional frequency conversion stage shown in FIG. 1, the TOI and the noise power of the frequency conversion stage are superimposed to illustrate the dynamic range of the frequency conversion stage, as shown in FIG. 2. The performance of spectrum analyzers and other types of receivers can be improved by enhancing dynamic range with an increase in the ratio of the TOI to the noise power (NP) of the frequency conversion stage of the receiver.

### BRIEF DESCRIPTION OF THE DRAWINGS

FIG. 1 shows a conventional frequency conversion stage of a receiver.

FIG. 2 shows an example performance characteristic of a conventional frequency conversion stage.

FIG. 3 shows an example of frequency converters according to embodiments of the present invention in the context of a spectrum analyzer.

FIGS. 4A-4B show examples of the frequency converters according to embodiments of the present invention.

FIG. 5 shows an example of a noise model for the frequency converters shown in FIGS. 4A-4B.

FIG. 6 shows one example of a comparison of dynamic range between a conventional frequency conversion stage and the frequency converters according to embodiments of the present invention.

FIG. 7 shows a detailed view of local oscillators suitable for use with the frequency converters according to embodiments of the present invention.

### DETAILED DESCRIPTION

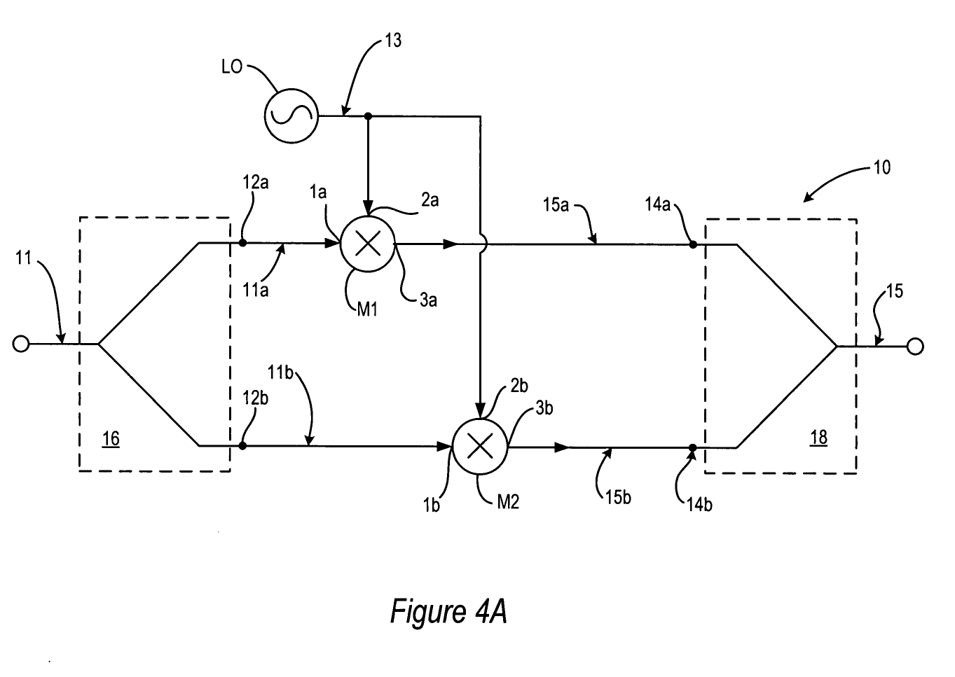

Frequency converters according to embodiments of the present invention are suitable for inclusion in communication systems, measurement receivers, spectrum analyzers, and other types of instruments or systems. For the purpose of illustration, the frequency converters are presented in the context of a front-end receiver 2 within a spectrum analyzer 3 as shown in FIG. 3.

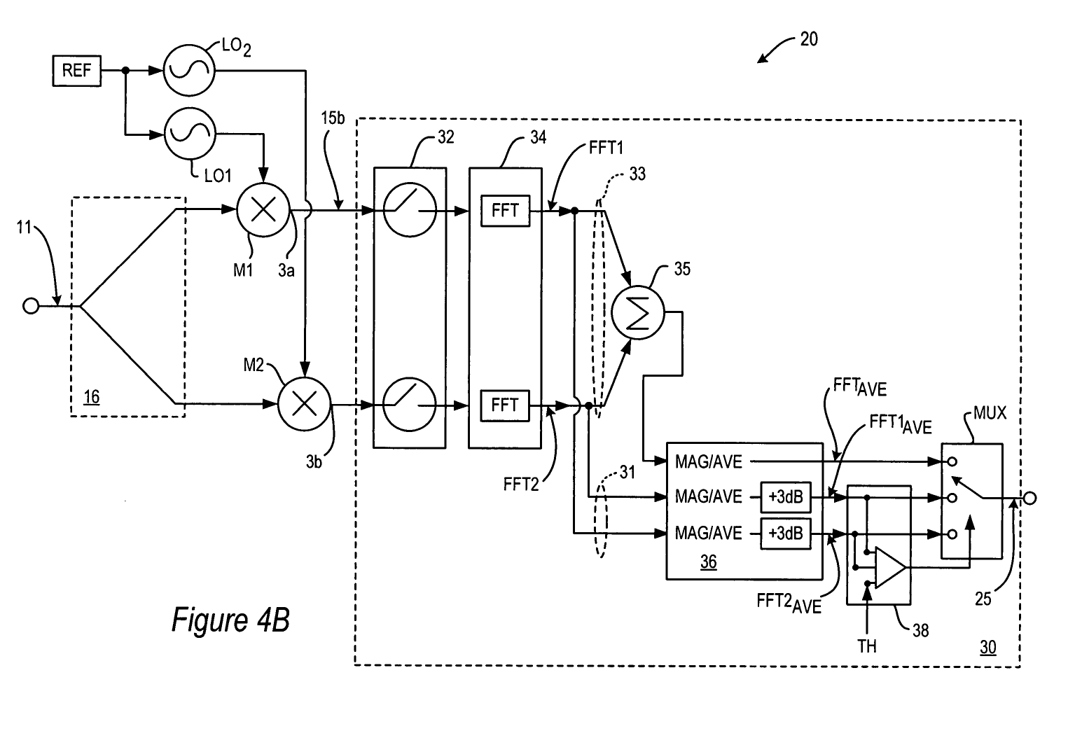

FIGS. 4A-4B show examples of frequency converters 10, 20 according to embodiments of the present invention. Each of the frequency converters 10, 20 translates an applied input signal 11 in frequency to provide an IF signal 15 as shown in FIG. 4A, or an IF signal 25 as shown in FIG. 4B. In the spectrum analyzer 3, the IF signal 15 is typically applied to an IF section 4. The IF section 4 and a display/processor 6 coupled to the IF section 4 then process the IF signal 15 to represent the frequency spectrum of the input signal 11 on a display 8 or other output device associated with the spectrum analyzer 3. The IF section 4, the display/processor 6, and processing that is suitable to represent the frequency spectra of input signals 11 applied to a spectrum analyzer 3 are known in art and are included, for example, in an AGILENT TECHNOLOGIES, INC. PSA series spectrum analyzer model E4440A.

In a spectrum analyzer 3, a tuneable bandpass filter, a lowpass filter, or other type of filter FIL is typically included in the front-end receiver 2 of the spectrum analyzer 3. The filter FIL pre-selects signals that are applied to the front-end receiver 2. Once pre-selected, the resulting signal, designated in FIGS. 4A-4B as the input signal 11, is applied to the frequency converters 10, 20 within the front-end receiver 2.

The frequency converter 10 shown in FIG. 4A includes a power splitter 16, a pair of mixers M1, M2, a power combiner 18, and a single local oscillator LO. For the purpose of illustration, signal losses, attenuation, or other inefficiencies in the power splitter 16 and the power combiner 18 are presumed negligible.

The power splitter 16 receives the input signal 11 that is applied to the frequency converter 10 and divides the amplitude of the input signal 11 to provide two signals 11a, 11b, that in this example have equal magnitude. The signal 11a at a first output 12a of the power splitter 16 is provided to an input 1a of the mixer M1. An LO signal 13 provided by the local oscillator LO is applied to an input 2a of the mixer M1. The mixer M1 has an output 3a that provides an IF signal 15a that is a version of the signal 11a that is translated in frequency based on the frequency of the LO signal 13.

The signal 11b at a second output 12b of the power splitter 16 is provided to an input 1b of the mixer M2. The LO signal 13 is also applied to an input 2b of the mixer M2. The mixer M2 has an output 3b that provides an IF signal 15b that is a version of the signal 11b that is translated in frequency based on the frequency of the LO signal 13.

The IF signal 15a and the IF signal 15b provided by the mixers M1, M2, respectively, are provided to inputs 14a, 14b of the power combiner 18. When the IF signal 15a and the IF signal 15b are provided by the mixers M1, M2, the power combiner 18 provides a combined IF signal 15 that is the vector sum of the IF signals 15a, 15b. The signal 11a and the signal 11b have the same frequency, and the signals 11a, 11b are both translated in frequency based on the frequency of the LO signal 13 that is applied to both mixers M1, M2. Accordingly, the resulting IF signals 15a, 15b that are vector summed to form the IF signal 15 are coherent and have the same frequency. The mixers M1, M2 are designated or selected to have matched amplitude and phase characteristics, and to the extent that the mixers M1, M2 have matched conversion loss and matched phase responses, the IF signals 15a, 15b have equal amplitude and phase.

To the extent that the power splitter 16 equally divides the amplitude of the input signal 11 between the signals 11a, 11b, each of the mixers M1, M2 is presented with one of the signals 11a, 11b having half of the power of the input signal 11. This division of the input signal 11 between the signals 11a, 11b results in the frequency converter 10 having a third-order intercept (TOI_{C}) that is higher than the third-order intercept of the mixer M1 and the third-order intercept of the mixer M2. For mixers M1, M2 with matched performance characteristics, the third-order intercept TOI_{C} of the frequency converter 10 is 3 dB higher than the TOI of each of the mixers M1, M2.

The vector sum of the coherent IF signals 15a, 15b provided by the power combiner 18 results in the IF signal 15 having a signal power that is equal to the sum of the signal power of the output signal 15a and the signal power of the output signal 15b. For mixers M1, M2 with matched amplitude and phase characteristics, the signal power of the IF signal 15 at the output of the power combiner 18 is 3 dB higher than the power of each of the output signals 15a, 15b.

A third-order dynamic range figure of merit, hereinafter “dynamic range FOM” of the frequency converter 10 is defined as the ratio of the third-order intercept TOI_{C} of the frequency converter 10 to the noise of the frequency converter 10. Accordingly, depicting the dynamic range FOM also involves determining the noise that is associated with the signals present in the frequency converter 10.

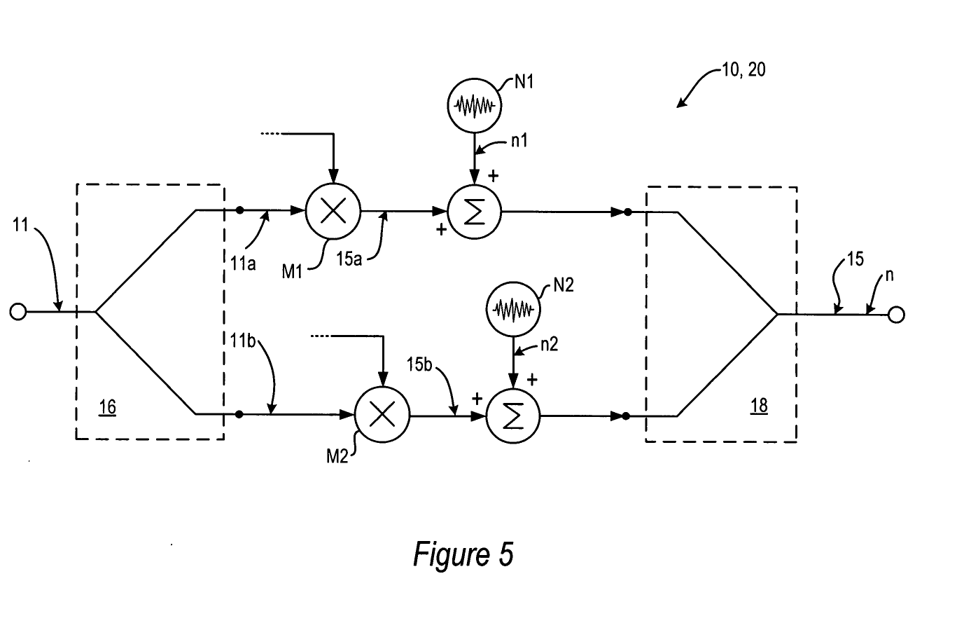

The noise in the frequency converter 10 is typically dominated by the noise added to the IF signals 15a, 15b at the outputs 3a, 3b of the mixers M1, M2. FIG. 5 shows an example of a noise model for the frequency converters 10, 20 shown in FIGS. 4A-4B. In the noise model, the outputs 3a, 3b of each of the mixers M1, M2 includes a corresponding noise source N1, N2, that adds noise signals n1, n2 to the IF signals 15a, 15b. The noise signals n1, n2 provided by each of the noise sources N1, N2 are also vector summed by the power combiner 18.

The noise signal n1 added to the IF signal 15a by the noise source N1 and the noise signal n2 added to the IF signal 15b by the noise source N2 are typically not coherent. Accordingly, when the power combiner 18 combines the incoherent noise signals n1, n2, a resulting noise signal n at the output of the power combiner 18 has a noise power that is the sum of half of the noise power of the noise signal n1, plus half of the noise power of the noise signal n2. By summing the coherent IF signals 15a, 15b and the incoherent noise signals n1, n2 with the power combiner 18, the ratio of the signal power of the IF signal 15 to the noise power of the noise signal n at the output of the frequency converter 10 increases by 3 dB.

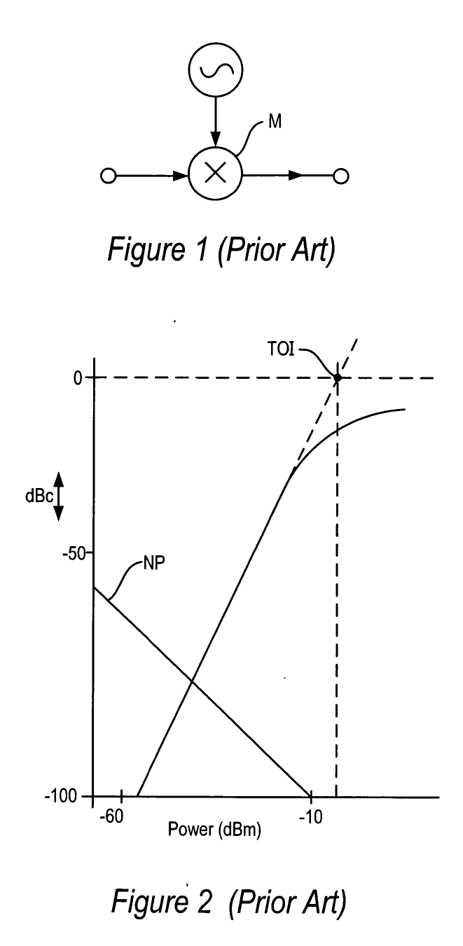

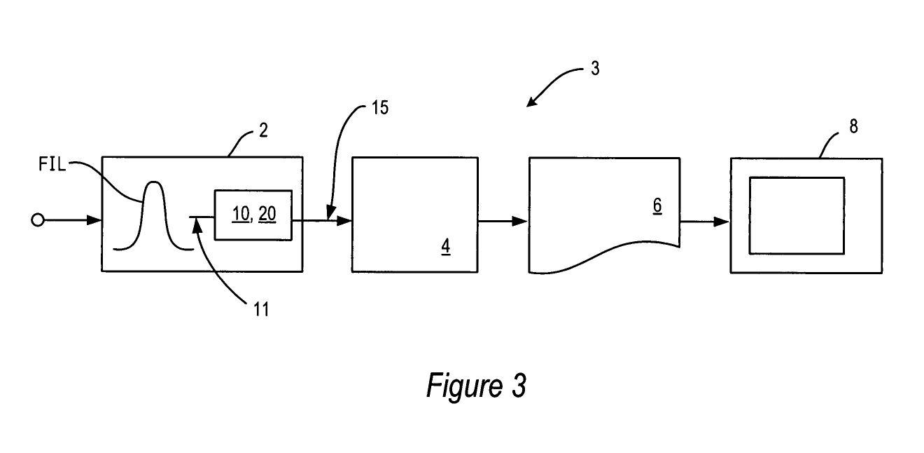

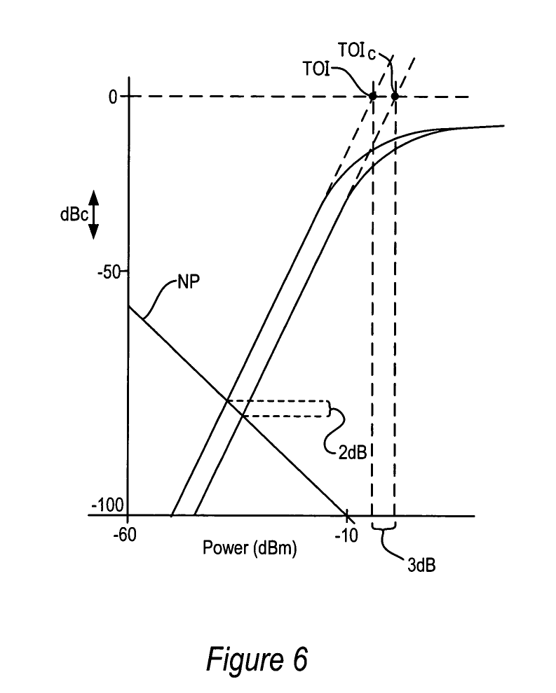

Relative to the third-order intercept TOI of the conventional frequency conversion stage (shown in FIGS. 1-2) that includes a single mixer M, the frequency converters 10, 20 according to embodiments of the present invention enable an increase in the third-order intercept TOI_{C} of 3 dB, as shown in FIG. 6. The lower incident power provided to each of the mixers M1, M2 resulting from the amplitude division of the input signal 11 by the power splitter 16 can reduce third-order distortion in each of the mixers M1, M2 by as much 9 dB, relative to the third-order distortion of the conventional frequency conversion stage shown in FIGS. 1-2 within which an input signal at full power is presented to the mixer M. The reduced third-order distortion in each of the resulting IF signals 15a, 15b is coherent, and when vector summed by the power combiner 18, the resulting third-order distortion of the IF signal 15 in the frequency converter 10 becomes 6 dB lower than the third-order distortion of the conventional frequency conversion stage shown in FIG. 1. The noise power NP measured in dBc relative to the power of the IF signal 15 typically does not increase correspondingly.

The frequency converter 10 has a dynamic range FOM that is increased by 3 dB, relative to the dynamic range FOM of the conventional frequency conversion stage, due to the 3 dB increase in the ratio of the third-order intercept TOI_{C} to the noise in the frequency converter 10. FIG. 6 shows one example comparison between a second measure of dynamic range of a conventional frequency conversion stage shown in FIG. 1 and the frequency converters 10, 20 according to embodiments of the present invention. The second measure of dynamic range, hereinafter “dynamic range”, illustrated in FIG. 6 and expressed in dBc, is defined as two-thirds of the dynamic range FOM. Therefore, while the frequency converters 10, 20 enable an increase in the dynamic range FOM of 3 dB as measured by the ratio of the TOI_{C} to the noise power NP, the frequency converters 10, 20 enable a corresponding enhancement of the dynamic range of 2 dB. When included in the front-end receiver 2 of a spectrum analyzer 3 or other type of receiver, the frequency converters 10, 20 enhances the dynamic range of the receiver. In the example of FIG. 6, the noise power NP, measured in dBc represents the noise in a designated noise bandwidth that is equal to 10 kHz.

The power splitter 16 included in the frequency converters 10, 20 is typically a minimum loss power splitter or power divider. Alternatively, the power splitter 16 is any device, element, or system suitable for amplitude-dividing the input signal 11 into two corresponding signals 11a, 11b, that have equal amplitudes, where the power splitter 16 operates over a frequency range that is sufficiently wide to accommodate the frequency range of the input signals 11 to the frequency converters 10, 20.

The power combiner 18 included in the frequency converter 10 is typically a minimum loss power combiner. In alternative examples, the power combiner 18 is any device, element, or system suitable for combining the IF signals 15a, 15b to form the IF signal 15, where the power combiner 18 operates over a frequency range that is sufficiently wide to accommodate the frequency range of the IF signal 15b. In general, the IF signal 15 has a lower frequency than the input signal 11, which enables the power combiner 18 to have a lower frequency operating range than the power splitter 16. Accordingly, the power combiner 18 can be readily implemented with passive circuit elements or structures, or with bipolar junction transistors, field effect transistors, digital circuitry, or with a variety of types and combinations of devices, elements or systems.

The mixers M1, M2 are typically implemented with switching diodes, bipolar junction transistors, field effect transistors or multiplier cells and typically include amplifiers cascaded with the switching elements or multiplying elements of the mixers M1, M2. The mixers M1, M2 are alternatively implemented using any device, element, or system suitable for translating the frequencies of signals 11a, 11b according to the frequency of the LO signal 13 in order to provide the IF signals 15a, 15b.

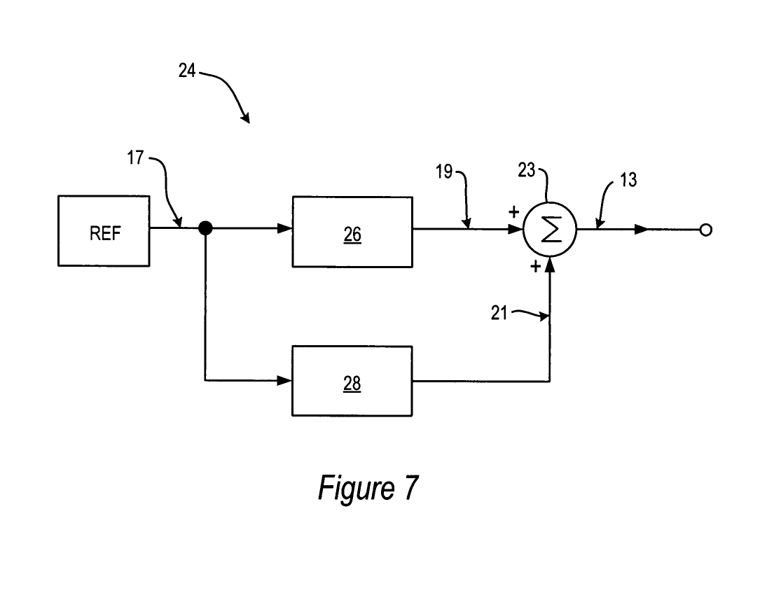

In a typical spectrum analyzer 3, the LO signal 13 provided to the frequency converter in the front-end receiver 2 is synthesized within the local oscillator LO using a dual phase locked loop (PLL) offset synthesizer 24 (shown in FIG. 7) that includes a main frequency synthesis loop 26 and an offset frequency synthesis loop 28. The main frequency synthesis loop 26 and the offset frequency synthesis loop 28 are each frequency-referenced to a frequency standard REF that provides a reference signal 17 at a frequency f_{ref}. The main frequency synthesis loop 26 provides a signal 19 at a frequency f_{MAIN}=M*f_{ref}, whereas the offset frequency synthesis loop 28 provides a signal 21 at a frequency f_{O/S}=N.P*f_{ref}. Typically, M and N are integers and P is a fraction of finite resolution, such that 0≦P<1. The term N.P in the frequency f_{O/S}=N.P*fref represents integer and fractional portions of a number that is equal to the sum N+P. The dual PLL offset synthesizer 24 includes a frequency summer 23 that sums the frequencies of the signal 19 from the main frequency synthesis loop 26 and the signal 21 from the offset frequency synthesis loop 28 to provide an LO signal 13 at a frequency f_{LO}=(M+N.P)*f_{ref}.

In addition to providing the LO signal 13 at the frequency f_{LO}, the dual PLL offset synthesizer 24 typically introduces one or more unwanted spurious signals on the LO signal 13 that occur at frequencies established by the values of M, N and P designated in the synthesis of the LO signal 13 by the main frequency synthesis loop 26 and the offset frequency synthesis loop 28. When the LO signal 13 is mixed with the signals 11a, 11b to provide the IF signals 15a, 15b, the IF signals 15a, 15b have synthesis spurs that are attributable to the unwanted spurious signals present on the LO signal 13. Synthesis spurs can be difficult to distinguish from other spectral attributes of the input signals 11 that are represented on the display 8 of a spectrum analyzer 3.

While the frequency converter 10 includes a single local oscillator LO, the frequency converter 20, shown in FIG. 4B, includes two local oscillators LO1, LO2 to enable synthesis spurs to be reduced, for example, when the spectra of input signals 11 are represented on the display 8 of a spectrum analyzer 3 within which the frequency converter 20 is included. In the example shown in FIG. 4B, each of the local oscillators LO1, LO2 includes a dual phase locked loop (PLL) offset synthesizer 24 (as shown in FIG. 7). The local oscillators LO1, LO2 provide corresponding LO signals 13a, 13b to the mixers M1, M2 in the frequency converter 20. The local oscillators LO1, LO2 are both referenced to the frequency standard REF so that the LO signals 13a, 13b have the same frequency f_{LO} and the same phase. However, each of the LO signals 13a, 13b is synthesized with a different combination of the frequencies in the main frequency synthesis loop 26 and the offset frequency synthesis loop 28 of the dual PLL offset synthesizer 24 within the corresponding local oscillators LO1, LO2. These different combinations of frequencies provide diversity in the spurious signals present on each of the LO signals 13a, 13b. The LO signal 13a is synthesized with the signals 19, 21 having a first combination of frequencies f_{MAIN1}, f_{O/S1}, provided by the main frequency synthesis loop 26 and the offset frequency synthesis loop 28, respectively, of the dual PLL offset synthesizer 24 in the local oscillator LO1. The LO signal 13b is synthesized with the signals 19, 21 having a second combination of frequencies f_{MAIN2}, f_{O/S2}, provided by the main frequency synthesis loop 26 and the offset frequency synthesis loop 28, respectively, of the dual PLL offset synthesizer 24 in the local oscillator LO2.

The different combinations of frequencies are provided by the main frequency synthesis loop 26 and the offset frequency synthesis loop 28 by designating the values of M, N, and P in dual PLL offset synthesizer 24 of each of the local oscillators LO1, LO2 so that each one of the LO signals 13a, 13b includes at least one spurious signal that is misaligned in frequency with all of the spurious signals in the other of the LO signals 13a, 13b. This diversity of spurious signals between the LO signal 13a and the LO signal 13b results in diversity between the synthesis spurs in the IF signal 15a and the IF signal 15b. Accordingly, each one of the IF signals 15a, 15b in the frequency converter 20 includes at least one synthesis spur that is misaligned in frequency with all of the synthesis spurs in the other of the IF signals 15a, 15b.

In the context of a spectrum analyzer 3 (shown in FIG. 3), the IF signals 15a, 15b that are provided by the frequency converter 20 are applied to a signal processor 30. The signal processor 30 suitably processes the IF signals 15a, 15b to enhance dynamic range and reduce synthesis spurs in the representations of the frequency spectra of input signals 11 on a display 8 of the spectrum analyzer 3. The signal processor 30 is typically integrated into the IF section 4 and the display/processor 6 of the spectrum analyzer 3.

The signal processor 30 includes a sample acquisition unit 32 that acquires one or more records of samples of each of the IF signals 15a, 15b in a time-synchronized fashion. The sample acquisition unit 32 is coupled to a Fast Fourier Transform (FFT) unit 34 that performs Fast Fourier Transforms on the acquired samples of each of the IF signals 15a, 15b, and provides the real component of the corresponding FFTs, designated as the signals FFT1, FFT2, respectively. Typically, multiple records of samples are acquired of each of the IF signals 15a, 15b, and the FFT unit 34 performs an FFT on each of the records. In a first processing path 31 in the signal processor 30, the magnitudes of the resulting signals FFT1, FFT2 are averaged in processing block 36 on a point-by-point basis to reduce noise in resulting averaged signals FFT1_{AVE}, FFT2_{AVE}, and the signal levels of the averaged signals FFT1_{AVE}, FFT2_{AVE} are increased in amplitude by 3 dB at each point. In a second processing path 33 in the signal processor 30, the signal FFT1 and the signal FFT2 are summed by a summer 35 to provide a resulting summed signal FFT. The summer 35 is typically a digital circuit that sums the signals FFT1, FFT2 on a point-by-point basis.

Multiple signals FFT1, FFT2 that correspond to the multiple acquired records of the IF signals 15a, 15b provide corresponding multiples of the summed signal FFT. These multiples of the summed signal FFT are also provided to the processing block 36, where the magnitudes of the summed signals FFT are averaged on a point-by-point basis to provide a resulting averaged signal FFT_{AVE}.

A comparison block 38 within the signal processor 30 compares the averaged signals FFT1_{AVE}, FFT2_{AVE} at each frequency point within the corresponding averaged signals FFT1_{AVE}, FFT2_{AVE}. At frequency points where the averaged signals FFT1_{AVE}, FFT2_{AVE} differ from each other by greater than a threshold amount TH, the comparison block 38 selects the signal level of the one of the averaged signals FFT1_{AVE}, FFT2_{AVE}, as level-adjusted by 3 dB, to be provided at the output of a multiplexer MUX. At frequency points where the averaged signals FFT1_{AVE}, FFT2_{AVE} do not differ from each other by greater than a threshold amount TH, the comparison block 38 selects the signal level of the averaged signal FFT_{AVE} to be provided at the output of a multiplexer MUX. This comparison, and conditional selection of signal levels performed at each frequency point by the multiplexer MUX provides an IF signal 25 that enables the spectrum analyzer 3 to represent the frequency spectrum of the input signal 11 on a display 8 or other output device associated with the spectrum analyzer 3. In the represented frequency spectrum of the input signal 11, spectral attributes of the input signal 11 can be more readily distinguished from the synthesis spurs present in each of the IF signals 15a, 15b, since one or more of the synthesis spurs in the IF signal 25 are identified and reduced on the basis of the frequency misalignment of the synthesis spurs between the IF signal 15a and the IF signal 15b. At frequency points where the signal level of the averaged signal FFT_{AVE} results in the IF signal 25, the frequency converter 20 provides an enhancement of the dynamic range as indicated in FIG. 6.

In the example of FIG. 4B, the signal processor 30 is represented by a series of functional blocks including the sample acquisition unit 32, the summer 35, an FFT unit 34, the processing block 36, the comparison block 38, and the multiplexer MUX. These functional blocks are for the purpose of illustrating the signal processor 30 and are typically distributed within hardware or software processing units within the signal processor 30.

While the embodiments of the present invention have been illustrated in detail, it should be apparent that modifications and adaptations to these embodiments may occur to one skilled in the art without departing from the scope of the present invention as set forth in the following claims.

1. A system, comprising:
amplitude-dividing an input signal into two signals;
applying a first signal of the two signals to a first mixer and a second signal of the two signals to a second mixer;
frequency translating the first signal according to a first LO signal applied to the first mixer to provide a first IF signal;
frequency translating the second signal according to a second LO signal applied to the second mixer to provide a second IF signal; and
summing the first IF signal and the second IF signal to provide an output IF signal.

2. The system of claim 1 wherein the first LO signal includes at least one spurious signal that is misaligned in frequency with each spurious signal in a set of one or more spurious signals included in the second LO signal.

3. The system of claim 1 wherein the second LO signal includes at least one spurious signal that is misaligned in frequency with each spurious signal in a set of one or more spurious signals included in the first LO signal.

4. The system of claim 1 wherein the first IF signal and the second IF signal have the same frequency and phase, and wherein the first LO signal and the second LO signal have spurious signal diversity.

5. The system of claim 1 wherein the first LO signal is synthesized with a first combination of frequencies provided by a main frequency synthesis loop and an offset synthesis loop of a first synthesizer, and the second LO signal is synthesized with a second combination of frequencies provided by a main frequency synthesis loop and an offset synthesis loop of a second synthesizer.

6. The system of claim 4 wherein the first LO signal is synthesized with a first combination of frequencies provided by a main frequency synthesis loop and an offset synthesis loop of a first synthesizer, and the second LO signal is synthesized with a second combination of frequencies provided by a main frequency synthesis loop and an offset synthesis loop of a second synthesizer.

7. The system of claim 1 further including a signal processor acquiring one or more records of samples of each of the first IF signal and the second IF signal.

8. The system of claim 7 wherein the signal processor provides a Fast Fourier Transform (FFT) of each of the acquired one or more records of the first IF signal and the acquired one or more records of the second IF signal, wherein the signal processor compares the FFT of the acquired one or more records of the first IF signal with the FFT of the acquired one or more records of the second IF signal, and wherein the signal processor adjusts the signal level of the output IF signal when the FFT of the acquired one or more records of the first IF signal and the FFT of the acquired one or more records of the second IF signal differ by greater than a predetermined threshold.

9. The system of claim 1 further comprising providing the output IF signal to the IF section of a spectrum analyzer.

10. A system, comprising:
amplitude-dividing an input signal into two signals;
applying each of the two signals to a corresponding mixer;
frequency translating each of the two signals according to an LO signal applied to the mixers to provide a first IF signal and a second IF signal, wherein the first IF signal and the second IF signal have a coherent signal component and an incoherent noise component; and
summing the first IF signal and the second IF signal to provide an output IF signal.

11. The system of claim 10 wherein the output IF signal has a coherent signal component having a power equal to the sum of the powers of the coherent signal components of the first IF signal and the second IF signal.

12. The system of claim 10 wherein the output IF signal has an incoherent noise component having a power equal to the sum of half of the power of the incoherent noise component of the first IF signal and half of the power of the incoherent noise component of the second IF signal.

13. The system of claim 11 wherein the output IF signal has an incoherent noise component having a power equal to the sum of half of the power of the incoherent noise component of the first IF signal and half of the power of the incoherent noise component of the second IF signal.

14. The system of claim 10 further including synthesizing the LO signal with a dual phase locked loop (PLL) offset synthesizer.

15. The system of claim 10 further comprising providing the output IF signal to an IF section of a spectrum analyzer.

16. A frequency converter, comprising:
a power splitter dividing an input signal into a first signal and a second signal;
a first mixer receiving the first signal and frequency translating the first signal according to a first LO signal to provide a first IF signal;
a second mixer receiving the second signal and frequency translating the second signal according to a second LO signal to provide a second IF signal;
a signal combiner summing the first IF signal and the second IF signal to provide an output IF signal.

17. The frequency converter of claim 16 wherein the first LO signal and the second LO signal are provided by a single local oscillator.

18. The frequency converter of claim 16 wherein the first LO signal is provided by a first local oscillator and the second LO signal is provided by a second local oscillator.

19. The frequency converter of claim 18 wherein each one of the first IF signal and the second IF signal has at least one synthesis spur that is misaligned in frequency with each of the synthesis spurs of the other of the first IF signal and the second IF signal.

20. The frequency converter of claim 18 wherein the first LO signal is synthesized with a first combination of frequencies provided by a main frequency synthesis loop and an offset frequency synthesis loop of a first synthesizer, and the second LO signal is synthesized with a second combination of frequencies provided by a main frequency synthesis loop and an offset frequency synthesis loop of a second synthesizer.
